(19) United States
(12) Patent Application Publication
(10) Pub. No.: US 2026/0155617 A1
(43) Pub. Date: Jun. 4, 2026

(54) INTRA-CAVITY GRATINGS FOR FREQUENCY COMB SPECTRUM MANIPULATION

(71) Applicant: Mellanox Technologies, Ltd., Yokneam (IL)

(72) Inventors: Roy RUDNICK, Tel Aviv (IL); Isabelle CESTIER, Haifa (IL); Elad MENTOVICH, Tel Aviv (IL)

(21) Appl. No.: 18/968,131

(22) Filed: Dec. 4, 2024

(51) Int. Cl. H01S 3/067; H01S 3/06; H01S 3/109; H01S 3/1115

(52) U.S. Cl. CPC H01S 3/0675; H01S 3/0625; H01S 3/109; H01S 3/1115

(57) ABSTRACT

A frequency comb generator is provided. The frequency comb generator includes an optical cavity having gain material disposed therein; and two or more waveguide gratings formed sequentially in the optical cavity. The two or more waveguide gratings are configured to control the emission spectrum of the frequency comb generator.

### BACKGROUND

As artificial intelligence and/or machine learning use increases, the amount of information being communicated between large clusters of computing resources (e.g., graphical processing units (GPUs), central processing units (CPUs), data processing units (DPUs), and/or the like) is also increasing. Wavelength division multiplexing (WDM) may be used to increase the density of interfaces between clusters of computing resources. WDM is conventionally accomplished using multiple distributed feedback (DFB) lasers. However, such implementations of WDM tend to have relatively large footprints and require substantial power consumption. Accordingly, a need exists for power efficient and size efficient optical sources for use in WDM applications.

### GENERAL DESCRIPTION

Datacenters rely on a fast and robust communication infrastructure. This is achieved by using optical interconnects, especially between different server racks. Each physical link employing a single optical fiber includes multiple communication channels, which are distinguished by different wavelengths in wavelength division multiplexing (WDM) systems.

Frequency comb lasers are a candidate light source for applications like dense wavelength division multiplexing (DWDM) due to their ability to generate a large number of spectral lines having a configurable line spacing. Frequency comb generators seek to replace arrays of discrete laser sources with one single wavelength laser source. The spectral lines from the laser are subsequently modulated separately such that individual spectral lines may be used to convey individual data streams. However, frequency comb lasers generate a large number of spectral lines including spectral lines outside of the wavelength range used for a particular DWDM application. These additional spectral lines in the output of the frequency comb laser may result in noise in the system and coupling these additional spectral lines out of the cavity of the frequency comb laser reduces the power within the cavity. By forming a number of sequential intra-cavity gratings, passbands may be defined that enable the frequency comb laser to emit the spectral lines within a desired wavelength range and to confine spectral lines outside of the desired wavelength range to within the cavity. This results in less noise in the output of the frequency comb laser and enables more energy efficient operation of the frequency comb laser, high optical power with configurable mode spacing frequency comb source. The transmitters in optical WDM transceiver modules are typically based on arrays of discrete single wavelength lasers, such as the distributed feedback (DFB) lasers or Distributed Bragg Reflector laser (DBR) lasers. However, in order to decrease power consumption and complexity, these lasers could be replaced by a single comb laser (e.g., a frequency comb generator). The comb laser generates a range of discrete, equally spaced frequencies.

As transceivers increase their line bitrate, currently from 25 Gbit/s to 50 Gbit/s and then to 100 Gbit/s and 200 Gbit/s, as well as upgrade the modulation order from present techniques like non-return-to-zero (NRZ) to pulse amplitude modulation level 4 (PAM-4), the challenge is how to scale the power consumption by the laser sources because these increments require an increase in the signal-to-noise ratio (SNR) of the transmitter.

For example, when moving from NRZ to PAM-4 at the same bitrate, the SNR is reduced by a factor of 3. Therefore, the power needs to increase by a factor of 3 just to maintain the same bit error rate (BER) count as before.

When moving from a PAM-4 to PAM-8 (PAM level 8), both operating at the same bitrate, the SNR needs to be increased to ensure the PAM-8 signal reach the same BER as in the case of PAM-4.

Supporting a sustainable relation between SNR and BER typically requires increasing the available power provided by the laser source, which increases cost. As a result, lasers need to generate more light, which in turn, increases the power consumption above a linear scaling and introduces heat dissipation strain and thermal management challenges, at the same time.

This is particularly relevant for transceivers that need to be encapsulated in standardized pluggable forms, which have limited heat dissipation properties and small space, such that they rely on air flow design, thereby limiting the amount of power transceivers can take from the main rack by the form-factor standards.

Frequency comb generators seek to replace arrays of discrete laser sources with one single laser source. The spectral lines from the laser are subsequently modulated separately such that individual spectral lines may be used to convey individual data streams.

Traditional frequency comb generators have been constructed using discrete components for applications that allow for a large footprint (e.g., by combining external elements of the frequency comb generator to form a cavity of the frequency comb generator), such as in the fields of metrology and sensing. Such devices, however, are bulky and do not meet requirements for the integrated photonics challenge.

Various embodiments provide frequency comb generators with active optical cavities. In various embodiments, the frequency comb generators are monolithic and/or on-chip frequency comb lasers. This enables a frequency comb generator to be directly integrated with a photonic integrated circuit, for example. The laser pulses generated by the frequency comb generator comprise discrete and regularly spaced spectral lines or “teeth.” These spectral lines or teeth may be used to perform dense WDM, in some embodiments. The frequency comb generator is capable of making an affordable, efficient, high optical power with configurable mode spacing frequency comb source. Dense low-power interfaces are paramount to continue scaling AI/ML systems to interconnect large clusters (GPUs, CPUs, DPUs, . . . ). Compared to multiple DFB lasers, implementation a monolithic frequency comb laser has a smaller footprint and lower power consumption.

In various embodiments, the frequency comb generator includes an active optical cavity. In some embodiments, the active optical cavity is defined, at least in part, by a reflector and a saturable absorber disposed at opposite ends of the optical cavity with gain material disposed therebetween. A ridge waveguide, possibly with cladding disposed thereon, extends along an optical axis of the optical cavity such that the ridge waveguide in optical communication with the within the gain material. For example, the optical axis of the ridge waveguide may pass through the gain material and a saturable absorber defining one end of the optical cavity. In various embodiments, two or more waveguide gratings are disposed in the ridge waveguide and/or cladding. The two or more waveguide gratings are configured to control which spectral lines of the frequency comb generated within the optical cavity are emitted as part of an emission subset of spectral lines and which spectral lines of the frequency comb generated within the optical cavity are confined with the optical cavity as part of a reflected subset of spectral lines.

In certain applications, a frequency comb generator may be coupled to an output waveguide (e.g., directly, evanescently, and/or the like). The output waveguide may be used to optically couple the frequency comb generator to one or more modulators, multiplexers, a photonic integrated circuit (PIC), and/or the like. For example, the frequency comb generator may be part of an interconnect used for optical communications.

The present disclosure describes interconnects (e.g., interconnect topologies) that are scalable and advantageous for networks that require a large number of all-to-all or point-to-point links between one or more node or send/receive pairs. In particular, silicon photonics interconnects or topologies are provided herein that may achieve at least moderate bandwidth between many nodes with physical, optical fiber connections. In some implementations, the one or more node or send/receive pairs are coupled with an optical fiber allowing a single wavelength to pass therebetween. In other implementations, multiple wavelengths or groups of wavelengths may be transmitted or received by nodes while simultaneously passing multiple wavelengths or groups of wavelengths to other nodes via optical fiber loops connecting three or more nodes. In some implementations, such interconnects as described herein do not rely on or include one or more of the following: wavelength synchronization between transmit and receive pairs, arbitration of the fiber(s), demultiplexers on the receiver side, and/or an optical crossbar. In some implementations, the optical interconnects may be sized to fit a face-plate form factor or as a mid-board optical connector or co-packaged optics. In some embodiments, the present disclosure provides optical interconnects for high bandwidth density applications like switches and GPUs.

A “node” as described herein may refer to a network switch to which a plurality of computer processing units (CPUs), graphical processing units (GPUs), data processing units (DPUs), or memory media are connected in an arbitrary number. The network switch may communicate with other network switches of the same kind to which the same processor and memory units may be connected. However, in other implementations, “node” may also refer to a processor which may be responsible for communication with all other nodes in the network or subnetwork.

An “optical fiber” as described herein can refer to a single optical fiber (e.g., including a core and a cladding) to provide unidirectional optical communication, can refer to a bidirectional pair of optical fibers (e.g., each including a core and a cladding) to provide both transmit and receive communications in an optical network, or can refer to a multi-core fiber, such that a single cladding could encapsulate a plurality of single-mode cores. Optical fibers can extend contiguously and uninterrupted between node or send/receive pairs (e.g., via pass-through connections) or include two or more fibers connected via fiber-to-fiber connections such that the fibers function or perform as a single fiber.

Silicon Photonics (SiP) is a technology that enables optical systems to be manufactured using silicon processes with silicon as the optical medium. Various optical components, such as interconnects and signal processing components, may be fabricated and integrated in a single SiP device. Some SiP devices are fabricated on a silica substrate or over a silica layer on a silicon substrate, a technology that is often referred to as Silicon on Insulator (SOI). In certain optical systems, a SiP device is attached to an external device to facilitate optical communications. However, it is generally difficult to accurately align light signals on the SiP with an external device that receives the light.

In certain optical systems, a SiP device is attached to an external device to facilitate optical communications. For example, the system includes one or more waveguides that carry light signals to and/or from optical chips. Examples of optical chips that can be included on the device include, but are not limited to, one or more components selected from a group consisting of facets through which light signals can enter and/or exit a waveguide, entry/exit ports through which light signals can enter and/or exit a waveguide from above or below the device, multiplexers for combining multiple light signals onto a single waveguide, demultiplexers for separating multiple light signals such that different light signals are received on different waveguides, optical couplers, optical switches, lasers that act as a source of a light signal, amplifiers for amplifying the intensity of a light signal, attenuators for attenuating the intensity of a light signal, modulators for modulating a signal onto a light signal, modulators that convert a light signal to an electrical signal, and vias that provide an optical pathway for a light signal traveling through the device. Additionally, the device can optionally, include electrical components. For instance, the device can include electrical connections for applying a potential or current to a waveguide, controlling active optical components, such as modulators, for example, and/or for controlling other components on the optical device.

According to an aspect of the present disclosure, a frequency comb generator is provided. The frequency comb generator is configured to generate a large number of spectral lines having a configurable line spacing. In an example embodiment, the frequency comb generator includes an optical cavity having gain material disposed therein and two or more waveguide gratings formed sequentially in the optical cavity. The two or more waveguide gratings are configured to control the emission spectrum of the frequency comb generator.

In general, the gain material may be any core material used to amplify light through the process of stimulated emission. The gain material may comprise Solid-State Gain Materials, Semiconductor Gain Materials, Gas Gain Materials or Fiber Optic Gain Materials. In some embodiments, the gain material comprises at least one of quantum dots, quantum dashes, or quantum wells of a III-V semiconductor material. The frequency comb generator may further include a first electrode and a second electrode wherein the gain material is disposed, at least in part, between the first electrode and the second electrode. In certain embodiments, the frequency comb pulses comprise a plurality of spectral lines characterized and/or separated from one another by a line spacing. In certain embodiments, the line spacing is at least 50 GHz. In some embodiments, the line spacing is at least 90 GHz.

In certain embodiments, the frequency comb generator further includes a reflector disposed at a first end of the optical cavity and a saturable absorber disposed at an opposite, second end of the optical cavity such that the reflector and the saturable absorber define the optical cavity. In some embodiments, an anti-reflective coating is disposed on an outer surface of the saturable absorber. In certain embodiments, the saturable absorber is electrically isolated from the gain material (e.g., via trenches, implantation, and/or the like).

In various embodiments, at least one of a waveguide or cladding extend along an optical axis defined by the optical cavity such that the waveguide is in optical communication with the gain material. In various embodiments, the two or more waveguide gratings are formed in the at least one of the waveguide or the cladding. In certain embodiments, the two or more waveguide gratings are formed by patterning the at least one of the waveguide or the cladding. In some embodiments, the two or more waveguide gratings are formed by modulating a refractive index of the at least one of the waveguide or the cladding along at least a portion of the optical axis.

In various embodiments, the two or more waveguide gratings are configured to cause a reflected subset of spectral lines formed by the optical cavity to remain within the optical cavity and to allow an emission subset of spectral lines formed by the optical cavity to be emitted from the optical cavity. In certain embodiments, the optical cavity is configured to use spectral lines of the reflected subset of spectral lines to perform four wave mixing within the optical cavity. In certain embodiments, the two or more waveguide gratings define respective passbands, the optical cavity generates a plurality of spectral lines, and the frequency comb generator emits an emission subset of the plurality of spectral lines, where each emitted line in the emission subset is characterized by a respective wavelength that is within one of the respective passbands.

In some embodiments, a pitch of at least one of the two or more waveguide gratings is chirped to change the reflection values of the pass band. In some embodiments, a pitch of at least one of the two or more waveguide gratings is constant across the at least one of the two or more waveguide gratings. In various embodiments, the optical cavity is one of a Fabry-Perot cavity or a colliding pulse cavity. The Fabry-Perot cavity provides the necessary feedback for the laser emission and defines the laser spectral properties: mode spacing, spectrum width. The spectral range is defined by the material gain spectrum and the modal spectrum. The two or more waveguide gratings formed sequentially in the optical cavity alter the spectral properties of the laser for desired passband and transmission percentage and enable to manipulate the generated spectrum to increase power efficiency, increase comb stability, truncate/filter part of spectrum for SNR, reflect back part of the spectrum to feed the comb laser by four wave mixing. The colliding pulse cavity is configured to exhibit increased gain compared to cavities of the same length while generating frequency comb pulses.

In various embodiments, the optical cavity is optically coupled to an output waveguide and the frequency comb generator is configured to provide frequency comb pulses to the output waveguide comprising an emission subset of spectral lines that is defined at least in part by the two or more waveguide gratings.

According to another aspect, a system is provided. The system includes a frequency comb generator, an output waveguide optically coupled to the frequency comb generator, and one or more downstream elements. The frequency comb generator includes an optical cavity having gain material disposed therein; and two or more waveguide gratings formed sequentially in the optical cavity. The two or more waveguide gratings are configured to control the emission spectrum of the frequency comb generator. The output waveguide provides frequency comb pulses generated by the frequency comb generator and characterized by the emission spectrum to the one or more downstream elements.

In an example embodiment, at least one of the one or more downstream elements is configured to perform dense wavelength division multiplexing using the frequency comb pulses. For example, the at least one of the downstream elements may use the spectral lines of the emission subset of spectral lines to perform dense wavelength division multiplexing.

In certain embodiments, the two or more waveguide gratings define respective passbands, the optical cavity generates a plurality of spectral lines, and the frequency comb generator emits an emission subset of the plurality of spectral lines, where each emitted line in the emission subset is characterized by a respective wavelength that is within one of the respective passbands, and at least one of the one or more downstream elements is configured to perform dense wavelength division multiplexing using spectral lines of the emission subset.

In certain embodiments, the two or more waveguide gratings are configured to define a reflected subset of spectral lines formed by the optical cavity and an emission subset of spectral lines formed by the optical cavity, the reflected subset of spectral lines are caused to remain within the optical cavity and the emission subset of spectral lines are emitted from the optical cavity. In some embodiments, the optical cavity is configured to use spectral lines of the reflected subset of spectral lines to perform four wave mixing within the optical cavity.

In various embodiments, the system is a transceiver or at least one of the one or more downstream elements is a transceiver in optical communication with the output waveguide via an optical interconnect.

### BRIEF DESCRIPTION OF THE SEVERAL VIEWS OF THE DRAWINGS

Reference will now be made to the accompanying drawings, which are not necessarily drawn to scale, and wherein:

FIG. 1 provides a top cross-sectional view of an example frequency comb generator including an active optical cavity having gain material and two or more waveguide gratings therein, in accordance with certain embodiments;

FIG. 1A provides a cross-sectional view taken along the line AA shown in FIG. 1, in accordance with certain embodiments;

FIG. 1B provides a cross-sectional view taken along the line BB shown in FIG. 1, in accordance with certain embodiments;

FIG. 1C provides an alternative cross-sectional view taken along the line BB shown in FIG. 1, in accordance with certain embodiments;

FIG. 2 provides a pair of plots showing simulation results of the effect of the two or more waveguide gratings formed in the optical cavity, in accordance with certain embodiments;

FIG. 3 provides a schematic illustration of the effect of the two or more waveguide gratings formed in the optical cavity on the spectral lines of the frequency φm spectrum, in accordance with certain embodiments;

FIG. 4 provides a block diagram of an example system including a frequency comb generator, according to certain embodiments;

FIG. 5A provides a block diagram of an example N-channel system including a frequency comb generator, according to certain embodiments;

FIGS. 5B-5D show schematic diagrams of three examples of frequency comb generators implemented in multi-chip modules (MCM) where a first substrate or die houses the frequency comb generator and a second substrate or die houses silicon photonics elements, according to some embodiments of the current disclosure;

FIG. 6 provides a block diagram of an example system that may include one or more optical chips according to certain embodiments;

FIG. 7 provides a schematic diagram of an example datacenter that may include one or more optical chips according to certain embodiments;

FIG. 8 provides a block diagram of two example communication devices in communication with one another according to certain embodiments; and

FIG. 9 depicts some exemplary scenarios for use of an optical transceiver, in accordance with various embodiments.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Various embodiments provide frequency comb generators with active optical cavities. An active optical cavity is an optical cavity where the gain material is disposed within the active optical cavity. In various embodiments, the frequency comb generators are monolithic and/or on-chip frequency comb lasers. This enables a frequency comb generator to be directly integrated with a photonic integrated circuit, for example. The laser/frequency comb pulses generated by the frequency comb generator comprise discrete and regularly spaced spectral lines or “teeth.” These spectral lines or teeth may be used to perform dense WDM, in some embodiments. For example, the frequency of an nth spectral line fₙ of a frequency comb pulse can generally be described as fₙ=f₀+n·fᵣ, where n is an integer, f₀ is the carrier offset frequency, and fᵣ is the comb tooth spacing. In certain embodiments (e.g., embodiments where the frequency comb generator is used as a laser source for dense WDM), the comb tooth spacing fᵣ is approximately 100 GHz or greater. For example, the comb tooth spacing fᵣ may be at least 50 GHz, or at least 90 GHz, in various embodiments.

In various embodiments, the frequency comb generator includes an active optical cavity. In some embodiments, the active optical cavity gain material disposed therein. In certain embodiments, the gain material can be made of III-V quantum dots, quantum wells, quantum dashes on a III-V or Si substrate. An output waveguide or waveguide bus may be evanescently or directly coupled to the optical cavity to provide the laser/frequency comb pulses to an optical system such as a modulator, multiplexer, optical chip, optical interconnect, and/or the like. The optical cavity may be configured to couple out a selected portion of the optical power from the active optical cavity that is less than 100%. The portion of the optical power that is not coupled out from the active optical cavity provides a feedback mechanism for mode coupling within the active optical cavity. In various embodiments, the output cavity is configured to couple out selected spectral lines (e.g., an emission subset of spectral lines) and to not couple out other lines (e.g., a reflected subset of spectral lines) generated within the optical cavity.

In certain applications, a frequency comb generator may be coupled to an output waveguide (e.g., directly, evanescently, and/or the like). The output waveguide may be used to optically couple the frequency comb generator to one or more modulators, multiplexers, a photonic integrated circuit (PIC), and/or the like. For example, the frequency comb generator may be part of an interconnect used for optical communications.

Wavelength division multiplexing (WDM) is used in various optical communications system to increase the density of interfaces between clusters of computing resources, for example. WDM is conventionally accomplished using multiple distributed feedback (DFB) lasers. However, such implementations of WDM tend to have relatively large footprints and require substantial power consumption.

According to various embodiments, a frequency comb generator is used to generate and provide a frequency comb (laser pulses comprising discrete and regularly spaced spectral lines or “teeth”) that may be used for WDM such as dense WDM (DWDM). DWDM is a form of WDM that multiplexes a plurality of wavelengths with adjacent wavelengths separated by about 100 GHz (e.g., approximately 0.8 nm), for example, when operating in the O band (˜1310 nm). A conventional frequency comb generator is a Fabry Perot cavity laser combined with a saturable absorber forming a mode-locked laser. The frequency mode spacing of a Fabry Perot cavity is

$$f = \frac{c}{2 nL}$$

where f is the frequency spacing, c is the speed of light, n is the refractive index of the materiel experienced by an optical mode (e.g., the mode effective refractive index, in some scenarios) and L is the cavity length. The modal gain per round trip is R₁R₂e^{G2L}, where R1 and R2 are the facet reflectance, G is the modal gain including mode propagation loss, and L is the cavity length. The longer the cavity length L, the higher the modal gain and the shorter the frequency spacing. In longer cavities, longer than the fundamental Fabry Perot length, such as long strips or colliding pulsed cavities, sampled gratings and phase shifts can be introduced to lock comb lines onto the grating grid.

For a desirable mode spacing (e.g., 50 to 100 GHz in DWDM application) around the emission range of 1310 nm, the comb laser cavity length is such that the number of modes generated exceed the usable numbers of modes for the system. These unused modes present in the frequency comb pulse result in noise in the system. In addition to reducing the signal-to-noise ratio (SNR) of the system, the emission of the unused modes results in reduced optical power within the optical that is then replaced by application of additional electrical energy. Therefore, technical problems exist regarding providing frequency comb generators exhibiting low noise (e.g., a high SNR) and energy/electrical power efficiency.

Various embodiments provide technical solutions to these technical problems. Various embodiments provide frequency comb generators that have active optical cavities having two or more waveguide gratings formed sequentially therein. An active optical cavity is an optical cavity having a gain material disposed within the active optical cavity. In certain embodiments, the optical cavity includes a waveguide (e.g., a ridge waveguide) in optical communication with the gain material. The waveguide gratings are formed in by patterning (e.g. etching and/or epitaxy regrowth) and/or modulating the refractive index within at least a portion of the waveguide or a cladding thereof to include a grating in the form of material refractive index change. The two or more waveguide gratings are configured to control an emission spectrum of the frequency comb generator. The grating transmission (wavelength bandpass) is dependent on effective refractive index change and length. Any diffraction order can be used, first order or higher to achieve the desired value of reflectivity.

For example, the two or more waveguide gratings are configured to define respective passbands. The passbands are configured such that the frequency comb generator emits an emission subset of the plurality of spectral lines generated within the optical cavity such that each emitted line in the emission subset is characterized by a respective wavelength that is within one of the respective passbands. The spectral lines generated within the optical cavity that are not characterized by a respective wavelength that is within one of the passbands form a reflected subset of spectral lines. The spectral lines of the reflected subset of spectral lines substantially remain within the optical cavity while the spectral lines of the emission subset of spectral lines are emitted from the optical cavity as a frequency comb pulse. The spectral lines of the emission subset of spectral lines may then be used to perform DWDM, for example, without the additional spectral lines adding noise to the system. Therefore, frequency comb generators of various embodiments are configured to provide improved SNR frequency comb pulses.

Moreover, the optical power of the spectral lines of the reflected subset of spectral lines is maintained within the optical cavity. For example, in some embodiments, the optical cavity is configured to use spectral lines of the reflected subset of spectral lines to perform four wave mixing pump within the optical cavity. This results in a more efficient use of electrical energy applied to the optical cavity. Thus, frequency comb generators of various embodiments are configured to operate with improved energy/electrical power efficiency.

Therefore, various embodiments provide technical improvements to the fields of frequency comb generators, WDM systems that may use frequency comb generators as a laser source, and/or related systems.

### Example Frequency Comb Generator

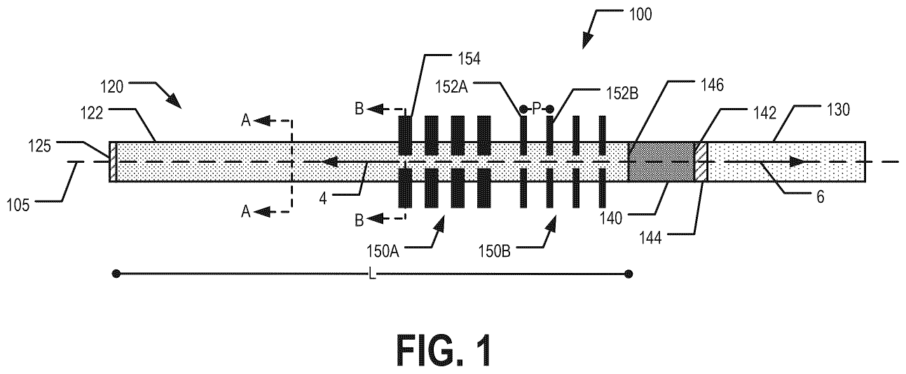

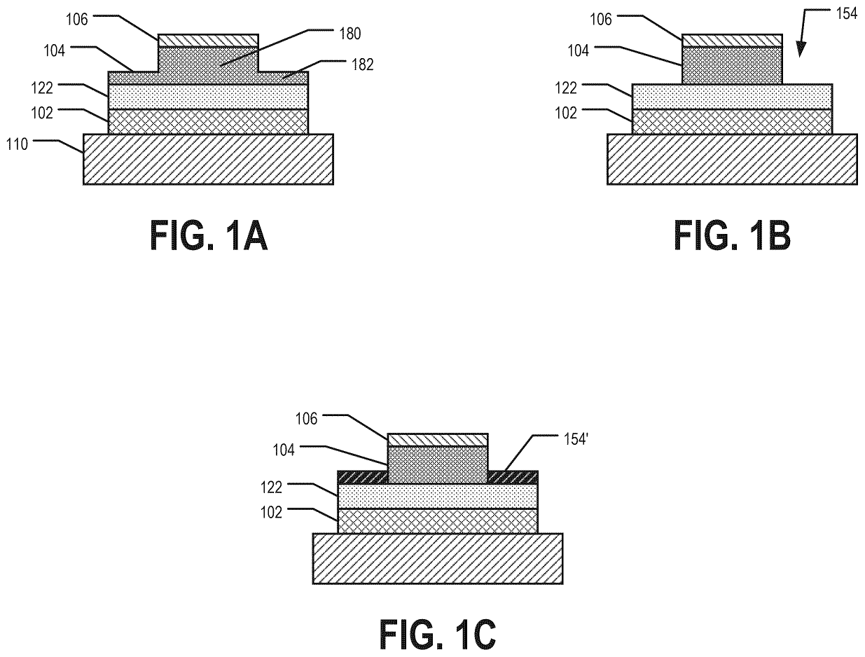

FIG. 1 illustrates an example frequency comb generator 100, according to an example embodiment. The illustrated frequency comb generator 100 includes an active optical cavity 120. The active optical cavity 120 includes gain material 122 disposed therein. In the illustrated embodiment, the active optical cavity is a linear optical cavity extending between a reflector 125 and a saturable absorber 140. In some embodiments, the active optical cavity may comprise a closed loop or ring of gain material, be a colliding pulse cavity, a Fabry-Perot cavity, and/or the like.

In various embodiments, the active optical cavity 120 is formed on a substrate 110 (as shown in FIGS. 1A-1C). In various embodiments, the substrate 110 is a silicon substrate, III-V semiconductor substrate, silica substrate, a silica layer on a silicon substrate, germanium substrate, gallium nitride substrate, sapphire, and/or another substrate appropriate for the application. The gain material 122 may comprise a III-V semiconductor material, such as GaAs; InP; InAs; GaN; InGaAs; or ternary and/or quaternary compounds with Ga, In, As, and/or P, for example. In various embodiments, the gain material 122 comprises quantum wells, quantum dashes, quantum dots, and/or the like. In various embodiments, the gain material may be configured to provide laser/frequency comb pulses having one or more spectral lines within a selected wavelength range or frequency band.

In some embodiments, confinement elements such as reflector 125 and saturable absorber 140 are located and/or disposed at opposite ends of the active optical cavity 120 so as to define, at least in part, the active optical cavity 120. In an example embodiment, a reflector 125 disposed at the first end of the active optical cavity is configured to be a high reflectivity mirror and/or a high reflectivity coating. For example, the reflector 125 may be configured to have a reflectivity of greater than 50% and possibly approaching 100% for light in a selected wavelength range or frequency band. In some embodiments, the reflector 125 is a distributed Bragg reflector. In certain embodiments, the reflector 125 is configured and/or tuned to pass a certain wavelength (e.g., a certain or specific spectral line(s)) therethrough for external use as feedback. For example, the certain or specifical spectral line(s) may be provided to a photodetector for monitoring the optical power within the optical cavity 120, and/or the like.

In certain embodiments, a saturable absorber 140 is an optical device that reduces its absorption of light as the intensity of the light increases. For example, the saturable absorber 140 may comprise gain material 122 that is biased in an opposite direction from a remainder of the gain material 122 of the active optical cavity 120. In certain embodiments, the saturable absorber 140 is electrically isolated from the gain material 122 of the active optical cavity 120 via trenches, implantation, and/or the like, and is reverse biased with respect to the gain material 122 of the active optical cavity 120.

In certain embodiments, a coating may be disposed on the outer surface 142 (e.g., back facet) or front facet 146 of the saturable absorber and configured to maximize the optical power of the emission subset of spectral lines that is emitted in a frequency comb pulse. For example, in certain embodiments, an anti-reflective coating 144 is disposed on an outer surface 142 (e.g. back facet) of the saturable absorber 140. In some embodiments, neither the front facet 146 nor the outer surface 142 (e.g., back facet) has an anti-reflective coating 144 formed thereon such that a portion of the optical power of the emission subset of spectral lines is reflected back into the active optical cavity 120 off of the outer surface 142 of the saturable absorber 140 creating a reflective pass band grating on the back side of the device. When more light is transmissive the lasing threshold will increase removing unwanted spectrum frequencies and improving SNR. In various embodiments, the saturable absorber 140 optically couples the active optical cavity 120 to an output waveguide or waveguide bus 130. In certain embodiments, the output waveguide or waveguide bus 130 is a silica waveguide or other type of waveguide appropriate for the application. The output waveguide or waveguide bus 130 may provide or guide frequency comb pulse 6 to a downstream element of the system including the frequency comb generator 100.

In various embodiments, the spectral lines of the frequency comb pulse 6 are used for a particular application (e.g., DWDM). For example, a frequency comb pulse substantially consisting of the spectral lines of an emission subset of spectral lines are coupled out of the active optical cavity 120 and into the output waveguide or waveguide bus 130 (e.g., to be provided to one or more downstream elements).

In various embodiments, the active optical cavity 120 may generate a plurality of spectral lines. The plurality of spectral lines may include more lines than are usable by the one or more downstream elements. Providing these unused spectral lines would result in additional noise in the system and a larger portion of the used spectral lines would need to be retained within the active optical cavity 120 to seed production of the next frequency comb pulse.

In various embodiments, two or more waveguide gratings 150 (e.g., 150A, 150B) are used to control the emission spectrum of the frequency comb generator 100. For example, the two or more waveguide gratings 150 may be configured to filter the spectral lines generated within the active optical cavity 120 into an emission subset of spectral lines which are emitted as a frequency comb pulse 6 and a reflected subset of spectral lines such that the reflected spectral lines 4 are substantially retained within the active optical cavity 120.

The illustrated active optical cavity 120 includes two waveguide gratings 150A, 150B characterized by different pitches. In various embodiments, the active optical cavity may include more than two waveguide gratings 150 (e.g., 150A, 150B). The upper limit on the number of waveguide gratings 150 that may be present in the active optical cavity 120 is dependent on the cavity length L of the active optical cavity 120 and the linear extent of each of the waveguide gratings 150. In certain embodiments, each waveguide grating 150 is characterized by a pitch that is different from the pitches of the other waveguide gratings 150.

The first waveguide grating 150A comprises a plurality of modified index of refraction portions 154 that are spaced along a portion of the optical axis 105. The second waveguide grating 150B comprises a plurality of modified index of refraction portions 152 (e.g., 152A, 152B) that are spaced along a portion of the optical axis 105. The spacing between respective modified index of refraction portions 152, 154 of a waveguide grating is referred to as the pitch of the grating. For example, the modified index of refraction portions 152A, 152B are separated from one another along the optical axis 105 by a pitch P.

In various embodiments, the pitch of each of the two or more waveguide gratings 150 are constant along the waveguide grating 150. In certain embodiments, the pitch of at least one of the two or more waveguide gratings 150 is chirped along the waveguide grating. For example, at least one of the two or more waveguide gratings 150 is a chirped grating (along the optical axis 105), in certain embodiments. A chirped grating is a grating where the pitch or grating period is not constant along the grating. For example, in a chirped grating the pitch or grating period of the grating may increase or decrease along the grating. In some embodiments, the pitch of at least one of the two or more waveguide gratings 150 is constant along the waveguide grating 150 and the pitch of at least another one two or more waveguide gratings 150 is chirped. In an example embodiment, each waveguide grating 150 of the two or more waveguide gratings is chirped grating.

For example, in an example embodiment, the waveguide gratings 150A, 150B are chirped (e.g., have chirped respective pitches) and an anti-reflective coating 144 is disposed on the outer surface 142 of the saturable absorber 140. According to simulation results, in such an embodiment, approximately 99% of the optical power in spectral lines of the reflected subset of spectral lines are retained within the active optical cavity and nearly 100% of the optical power in spectral lines of the emission subset of spectral lines is coupled into the output waveguide or waveguide bus 130 as a frequency comb pulse 6.

In another example embodiment, the waveguide gratings 150A, 150B are chirped (e.g., have chirped respective pitches) and an anti-reflective coating 144 is not disposed on the outer surface 142 of the saturable absorber 140. According to simulation results, in such an embodiment, approximately 99% of the optical power in spectral lines of the reflected subset of spectral lines are retained within the active optical cavity and about 70% of the optical power in spectral lines of the emission subset of spectral lines is coupled into the output waveguide or waveguide bus 130 as a frequency comb pulse 6. For example, about 30% of the optical power in spectral lines of the emission subset of spectral lines is reflected by the saturable absorber 140 (e.g., the outer surface 142 of the saturable absorber) back into the active optical cavity 120.

In another example embodiment, the waveguide gratings 150A, 150B are not chirped (e.g., have respective consistent/uniform pitches) and an anti-reflective coating 144 is disposed on the outer surface 142 of the saturable absorber 140. According to simulation results, in such an embodiment, approximately 99% of the optical power in spectral lines of the reflected subset of spectral lines are retained within the active optical cavity and about 70% of the optical power in spectral lines of the emission subset of spectral lines is coupled into the output waveguide or waveguide bus 130 as a frequency comb pulse 6. For example, about 30% of the optical power in spectral lines of the emission subset of spectral lines is reflected by the unchirped waveguide gratings 150 such that about 30% of the optical power in spectral lines of the emission subset of spectral lines is retained within the active optical cavity 120.

FIG. 1A illustrates a cross-section of the active optical cavity 120 taken in a plane that is substantially perpendicular to the optical axis 105 of the active optical cavity 120 at a location along the active optical cavity that is not within a modified index of refraction portion. As shown in FIG. 1A, the gain material 122 is disposed between a first electrode 102 and a second electrode 106. For example, the first electrode 102 may be formed on the substrate 110, the gain material 122 may be formed at least in part on the first electrode 102, a ridge waveguide 104, possibly including cladding, may be formed on the gain material 122, and the second electrode 106 may be formed on the gain material 122. Application or injection of current or voltage to the first electrode 102 and/or the second electrode 106 causes the gain material to generate photons within the active optical cavity 120. In various embodiments, the first electrode 102 and the second electrode 106 comprise a conductive material such as a metal or another appropriate material.

In various embodiments, the first electrode 102 and the second electrode 106 are oppositely doped materials. In an example embodiment, the first electrode 102 comprises an n-doped material and/or is a portion of the substrate 110 that is n-doped and the second electrode 106 comprises a p-doped material. In another example embodiment, the first electrode 102 comprises a p-doped material and/or is a portion of the substrate 110 that is p-doped and the second electrode 106 comprises an n-doped material.

In an example embodiment, the first electrode 102 is configured to be placed into electrical communication with an electrical current or voltage source (or local ground) via a lead formed on or in the substrate 110, a through via through the substrate 110, and/or the like. In an example embodiment, the second electrode 106 may be configured to be placed into electrical communication with an electrical current or voltage source (or local ground). For example, an electrical lead or other electrical contact may be formed between the exposed surface of the second electrode 106 (and/or a conductive electrode pad formed thereon) and a voltage and/or current source to apply an electrical current and/or voltage to the second electrode 106.

The ridge waveguide 104 includes a central ridge portion 180 and side portions 182. The height or thickness of the of the central ridge portion 180 is larger than that of the side portions 182. In other words, the distance that the central ridge portion 180 extends from the surface of the gain material 122 is greater than the distance that the side portions 182 extend from the surface of the gain material 122. In some embodiments, the side portions 182 are formed of cladding material and the central ridge portion 180 is formed of a waveguide formed of a waveguide material, which is possibly at least partially enclosed in cladding formed of a cladding material. In some embodiments, the side portions 182 comprise waveguide material in addition to or instead of cladding material.

In various embodiments, the longitudinal mode confinement of the waveguide is provided by the waveguide being formed of an epitaxy layer stack configured such that the mode is confined to specific layers. The transverse mode confinement of the waveguide is obtained by etching a waveguide in the epitaxy layer stack (e.g., the central ridge portion 180 and/or the side portions 182) and passivating the epitaxy layer stack by covering it in a cladding material. For example, the cladding material may be or comprise SiO₂, SiN, Benzocyclobutene (BCB), and/or the like.

In various embodiments, the side portions 182 are symmetric with respect to the optical axis 105. For example, the side portions 182 may have a fold or mirror symmetry with respect to the optical axis 105.

As noted above, each waveguide grating 150 comprises a respective plurality of modified index of refraction portions 154, 152. In various embodiments, the plurality of modified index of refraction portions 154, 152 are formed by modifying an index of refraction of at least the side portions 182 of the ridge waveguide 104 within the modified index of refraction portions.

In some embodiments, the plurality of modified index of refraction portions 154, 152 of a waveguide grating 150 are formed by patterning or etching the ridge waveguide 104. For example, FIG. 1B illustrates a cross-section of the active optical cavity 120 taken in a plane that is substantially perpendicular to the optical axis 105 of the active optical cavity 120 at line BB (e.g., at a location along the active optical cavity that is within a modified index of refraction portion). For example, the ridge waveguide 104 has been patterned or etched to remove the side portion 182 of the ridge waveguide 104 within the modified index of refraction portion 154. In other words, the index of refraction of the ridge waveguide 104 and/or at least the side portions 182 thereof within the modified index of refraction portion 154 shown in FIG. 1B is modified (compared to the ridge waveguide 104 outside of the modified index of refraction portion) by removing the waveguide and/or cladding material of at least some of the side portions 182.

In some embodiments, the plurality of modified index of refraction portions 154, 152 of a waveguide grating 150 are formed by modulating the index of refraction of the ridge waveguide 104. For example, FIG. 1C illustrates a cross-section of an active optical cavity 120 taken in a plane that is substantially perpendicular to the optical axis 105 of the active optical cavity 120 at line BB (e.g., at a location along the active optical cavity that is within a modified index of refraction portion). For example, the index of refraction of the ridge waveguide 104 and/or at least the side portions 182 thereof, has been modulated by changing the material of the waveguide and/or cladding within at least the side portions 182 within the modified index of refraction portion 154′. In other words, the index of refraction of the ridge waveguide 104 and/or at least the side portions 182 thereof within the modified index of refraction portion 154′ shown in FIG. 1C is modified (compared to the ridge waveguide 104 outside of the modified index of refraction portion) by changing the waveguide and/or cladding material of at least some of the side portions 182.

In some embodiments, the material of the waveguide and/or cladding material of the side portions 182 within the modified index of refraction portions 154′ may be a different material compared to the waveguide and/or cladding material of the side portions 182 outside of the modified index of refraction portions. In certain embodiments, the waveguide and/or cladding material of the side portions 182 within the modified index of refraction portions 154′ may be a same material as the waveguide and/or cladding material of the side portions 182 outside of the modified index of refraction portions 154′, but that is doped differently (e.g., doped to a different concentration and/or using different dopants). For example, in certain embodiments the cladding material is a doped silica and the doped silica within the modified index of refraction portions 154′ is more heavily doped compared to the doped silica located outside the modified index of refraction portions 154′.

The waveguide gratings 150A, 150B are sequentially placed along the optical axis 105 of the active optical cavity 120. As used herein, the waveguide gratings 150A, 150B are sequential because they are positioned such that the first waveguide grating 150A does not overlap with the second waveguide grating 150B. In other words, no modified index of refraction portions 152 of the second waveguide grating 150B are disposed between modified index of refraction portions 154 of the first waveguide grating 150A, and vice versa.

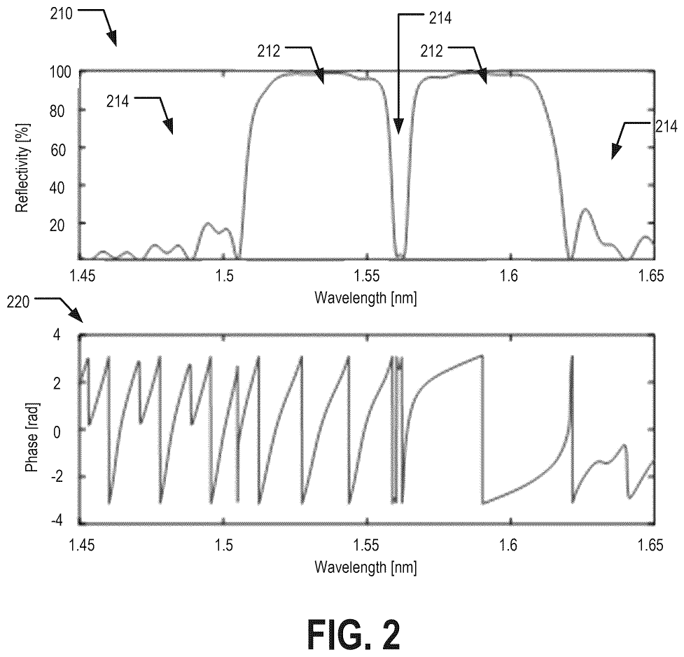

FIG. 2 provides simulation results for an example frequency comb generator 100 including two sequential waveguide gratings 150. The first plot 210 illustrates the reflectivity spectrum of the two or more waveguide gratings 150 as a function of wavelength. The first plot 210 shows low reflectivity wavelength ranges 214 where the reflectivity of the two or more waveguide gratings is less than 40% and, in some cases, less than 20%. An emission subset of spectral lines consists of spectral lines characterized by wavelengths in the low reflectivity wavelength ranges 214 while the reflected frequencies stay in the cavity to further optically pumping the device. The spectral lines of the emission subset of spectral lines pass through the waveguide gratings 150 such that they are emitted by the frequency comb generator 100. For example, the frequency comb pulse 6 (substantially) consists of spectral lines of the emission subset of spectral lines.

For example, the two or more waveguide gratings 150 are configured to define one or more passbands, where the one or more passbands correspond to the low reflectivity wavelength ranges 214. The active optical cavity 120 generates a plurality of spectral lines, and the frequency comb generator 100 emits an emission subset of the plurality of spectral lines, where each emitted line in the emission subset is characterized by a respective wavelength that is within one of the respective passbands. For example, the two or more waveguide gratings 150 are configured to allow an emission subset of spectral lines formed within the active optical cavity 120 to be emitted from the active optical cavity 120 (e.g., coupled into the output waveguide or waveguide bus 130.

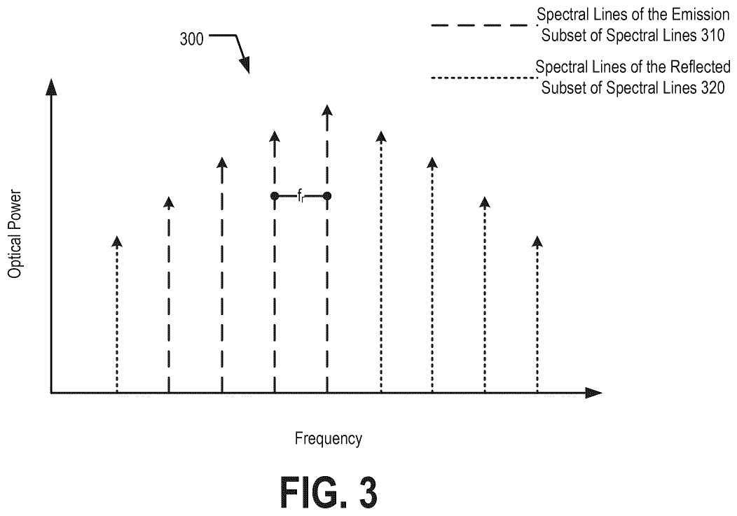

FIG. 3 illustrates an example spectrum 300 of a frequency comb generator 100. The spectrum 300 comprises a plurality of spectral lines that are equally spaced in frequency. The optical power of various lines may vary. The dashed spectral lines illustrate the spectral lines of an example emission subset of spectral lines 310. For example, a frequency comb pulse 6 emitted by the frequency comb generator 100 would substantially consist of the spectral lines of the emission subset of spectral lines. In this example the grating(s) filtered the longer wavelength modes.

Notably, as shown in first plot 210 of FIG. 2, there are high reflectivity wavelength ranges 212 where the reflectivity of the two or more waveguide gratings 150 is approximately 100%. A reflected subset of spectral lines consists of spectral lines characterized by wavelengths in the high reflectivity wavelength ranges 212. The spectral lines of the reflected subset of spectral lines are reflected by the waveguide gratings 150 such that they are not emitted by the frequency comb generator 100. For example, the frequency comb pulse 6 (substantially) does not include spectral lines of the reflected subset of spectral lines. For example, the two or more waveguide gratings 150 are configured to cause a reflected subset of spectral lines formed by the active optical cavity 120 to remain within the active optical cavity 120.

For example, the dotted spectral lines of the spectrum 300 shown in FIG. 3 illustrate the spectral lines of an example reflected subset of spectral lines 320. For example, a frequency comb pulse 6 emitted by the frequency comb generator 100 would be substantially free of the spectral lines of the reflected subset of spectral lines.

In some embodiments, the optical cavity is configured to use spectral lines of the reflected subset of spectral lines to perform four wave mixing within the active optical cavity 120. The second plot 220 illustrates the effect of the two waveguide gratings 150 on the phase of light as a function of wavelength. In various embodiments, the phase of spectral lines of the reflected subset of spectral lines is conditioned and/or modified (e.g., via interaction with the waveguide gratings 150) to cause four wave mixing within the active optical cavity 120 so as to convert some of the optical power within the active optical cavity 120 in spectral lines of the reflected subset into spectral lines of the emission subset.

### Example System Including a Frequency Comb Generator

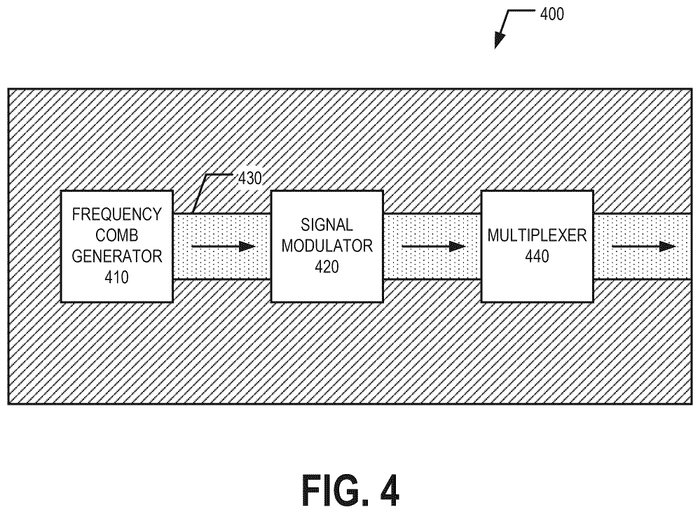

FIG. 4 illustrates an example system 400 including a frequency comb generator 410. For example, a frequency comb generator 410 may be a frequency comb generator having closed loop or ring of gain material disposed within the active optical cavity and/or having a gain material section divided into a plurality (e.g., two or more) segments with at least one of the segments being a flared or tapered segment. The output waveguide or waveguide bus 430 guides and/or provides laser/frequency comb pulses generated and provide by the frequency comb generator 410 to one or more downstream elements of the system 400 that use the laser/frequency comb pulses to perform various tasks, optical communications, and/or the like.

For example, the output waveguide or waveguide bus 430 may guide and/or provide the laser/frequency comb pulses to a signal modulator 420. In certain embodiments, the signal modulator 420 is configured to modulate one or more spectral lines of sequence or train of laser/frequency comb pulses so as to encode information therein/thereon. A waveguide, optical fiber, and/or the like may provide the laser/frequency comb pulses having the one or more modulated spectral lines to a multiplexer 440 that may be used to multiplex the one or more modulated spectral lines. The laser/frequency comb pulses may then be transmitted along a waveguide, optical fiber, and/or the like to communicate the information encoded therein/thereon with one or more downstream elements (e.g., an optical receiver and/or the like).

In various embodiments, the system 400 is or includes a high-speed transceiver. In some embodiments, the system 400 is or is part of a multi-chip module (MCM). In some embodiments, the frequency comb generator 410 is formed on the same substrate or die as other components of the transceiver (e.g., signal modulator 420, multiplexer 440, and/or the like). In certain embodiments, the frequency comb generator 410 is formed on a first substrate or die and the transceiver is formed on a second substrate or die and the frequency comb generator 410 is in optical communication with the transceiver via an optical interconnect (e.g., optical fiber, polymer flex waveguide, and/or the like optically coupled to output waveguide or waveguide bus 430). For example, in some embodiments, the downstream elements of the system 400 (e.g., to which laser/frequency comb pulses generated by the frequency comb generator 410 are provided via the output waveguide or waveguide bus 430) one or more optical interconnects and one or more transceivers.

There are different techniques of implementation to modulate the light coming out of the frequency comb generator 410. In an example embodiment, the frequency comb generator 410 provides laser/frequency comb pulses including a plurality of equidistantly spaced (in wavelength space) spectral lines, then the different wavelengths are filtered by dedicated filters. Each filter has a central wavelength designed to match one of the spectral lines of the plurality of spectral lines at that wavelength only. The signal from that filter, which is a narrow wavelength band (sometimes called a single wavelength, even though it has a bandwidth), is then sent to an optical modulator, for example, a Mach-Zehnder modulator, which modulates the optical signal by an electrical signal. The electrical signal may be a non-return to zero (NRZ) modulator, a four-level pulse amplitude modulator (PAM-4), or a modulator applying any multi-level signal conveying device technique, for example, like coding digital information into any format.

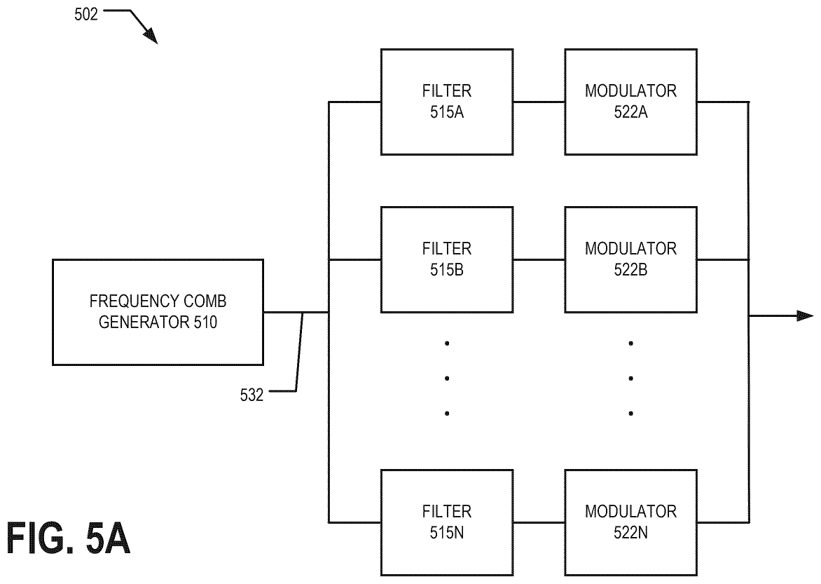

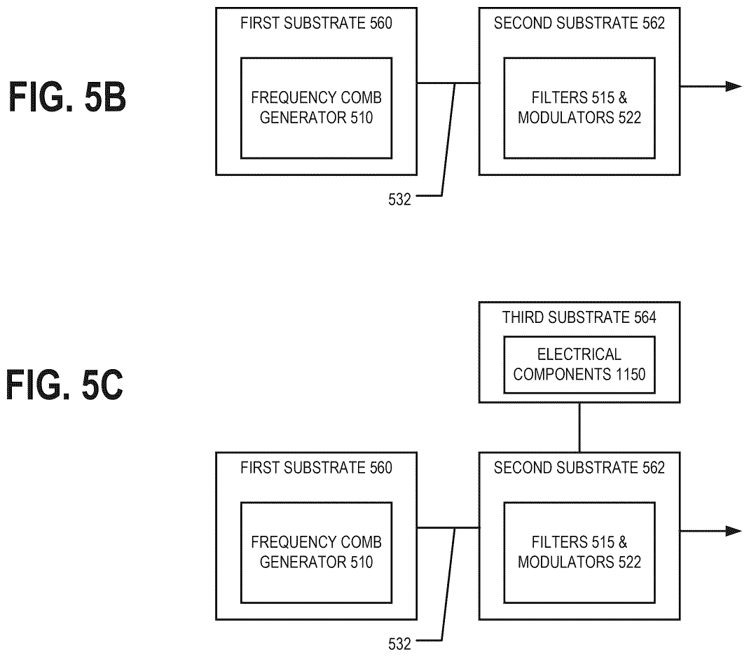

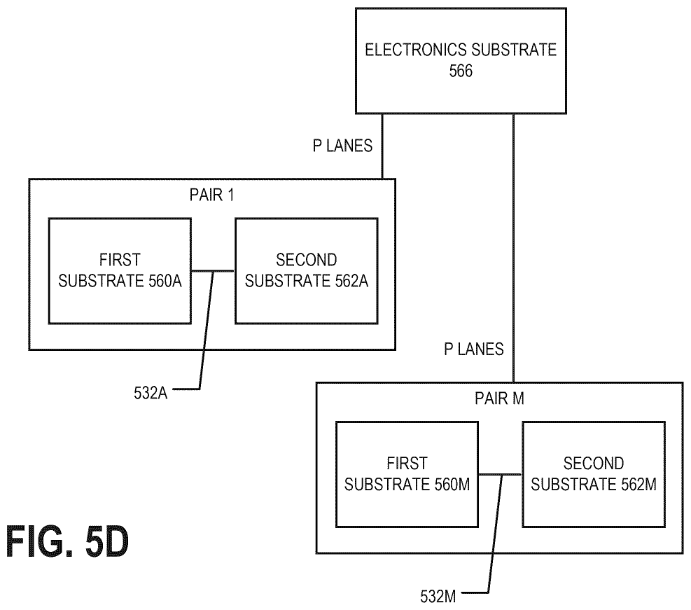

FIG. 5A illustrates an example system 502 where a frequency comb generator 510 is incorporated into an N-channel system with each filter including a respective filter 515A, 515B, . . . , 515N. For example, the system 502 implements a filtering technique where a dedicated filter 515A, 515B, . . . , 515N is employed for each spectral line responding to one wavelength band. This dedicated filter extracts the wavelength band and sends the respective single spectral line to a respective modulator 522A, 522B, . . . , 522BN, and the respective modulator performs phase modulation or amplitude modulation according to applications. The modulator can be a Mach-Zehnder modulator, a micro-ring modulator, and/or the like. For example, the filters 515A, 515B, . . . , 515N each extract a single respective spectral line form the emission spectrum of the frequency comb generator and provide the single respective spectral line to a respective modulator such that the single respective spectral line is used as a carrier signal that may be used for communicating information. For example, the frequency comb generator 510 provides laser/frequency comb pulses which are provided, via optical interconnect 532 (e.g., optical fiber, polymer flex waveguide(s), and/or another waveguide(s)) to a number of filters 515A, 515B, . . . , 515N that are used to separate the lines of the frequency comb, and a number of modulators 522A, 522B, . . . , 522N, each following one of the filters, are used to independently modulate that spectral line. For example, the system 502 includes N channels and the frequency comb generator is in optical communication with N channels, and each channel is formed of one filter and one modulator connected in series. The outputs of the N channels are combined into optical fiber cables to provide a single output comprising a plurality of individually modulated spectral lines.

FIGS. 5B-5D show schematic diagrams of three example systems including frequency comb generators 510 implemented in multi-chip modules (MCM), which include a first substrate or die housing the frequency comb generator and a second substrate or die housing the filtering and modulation components (e.g., filters 515A, . . . , 515N and modulators 522A, . . . , 522N). In some of the illustrated embodiments, the system includes a third substrate or die housing electronic components of the system.

In FIG. 5B, there are two substrates or dies—a first substrate or die 560 housing the frequency comb generator 510 and a second substrate or die 562 housing photonic components such as the filters 515 and modulators 522. For example, the second substrate or die 562 a silicon photonics chip housing a photonic integrated circuit. The first substrate or die 560 and the second substrate or die 562 are interconnected through an optical conduit or interconnect 532 made of an optical fiber, a polymer waveguide, a glass waveguide, or other interconnecting lines. In various embodiments, the second substrate or die 562 includes filtering and modulation blocks to select and modulate each separate spectral line of the laser/frequency comb pulses provided by the frequency comb generator 510.

In FIG. 5C, the system in FIG. 5B is extended with a third substrate or die 564, which is an electronics die containing all the systems for electronic manipulation of signals, including but not limited to equalization, coding, switching, and logic operations.

In FIG. 5D, the multichip module (MCM) implementation is further extended. A central electronics substrate or die 566 containing all signal manipulation electronics is surrounded by M pairs of photonics substrates or dies. Each pair of photonics substrates or dies includes a first substrate or die 560A, . . . , 560M housing a respective frequency comb generator 510 and a second substrate or die 562A, . . . , 562M of silicon photonics for frequency combing (e.g., filtering, modulating of individual spectral lines, and combining the plurality (e.g., N) of individually modulated spectral lines). Each pair of first substrate or die 560 and second substrate or die 562 are interconnected by a respective optical interconnect 532A, . . . , 532M such as a conduit of optical fibers, a polymer waveguide, or a glass waveguide, similar to the system described in FIG. 5B. The central electronics substrate or die 566 is connected to each of the photonics pair of first substrate or die 560 and second substrate or die 562 through Planes of electrical connections. The P planes of electrical connections may include power lanes, low frequency lanes, and/or high frequency lanes.

The integration of frequency comb generators into transceivers also offers the opportunity to extend a transceiver from a wavelength WDM source, for example, a four-wavelength channel scheme, to coarse-WDM (CWDM) as in eight wavelength channels. The similar frequency comb generators can be used to generate either four wavelengths to feed a WDM link or eight wavelengths to feed a CWDM link. In some embodiments, integration of frequency comb generators into transceivers further enables extension to dense WDM (DWDM).

For example, in certain embodiments a multi-chip module (MCM) has M photonics frequency comb generators 510, each comprising a pair of the first substrate and a second substrate. In some examples, the MCM further comprises an electronics substrate connecting to the M photonics frequency comb generators, respectively, via a multi-lane electrical connection, wherein the electronics substrate or die 566 comprises circuits for electronic manipulation of signals, including equalization, coding, switching, and logic operations.

### Example Datacenter

In various embodiments, a system including a frequency comb generator (e.g., system 500) may be part of a datacenter. For example, system may be part of a transceiver, interconnect and/or the like used to place various components of a datacenter in communication with one another. In various embodiments, the system 500 may be a pluggable optical interconnect that uses a frequency comb generator of an example embodiment as a laser source, a chip-to-chip optical interconnect that uses a frequency comb generator of an example embodiment as a laser source, a DWDM source, and/or the like. For example, a system 500 may be used to (optically) transmit data between components of a datacenter, in various embodiments. For example, a frequency comb generator 100 may be used to generate optical signals that are transmitted along one or more optical communication paths between two components of a datacenter, in accordance with an example embodiment.

Datacenters may include multiple network switches in a particular topology, such as a fat tree topology, a slim fly topology, a dragonfly topology, and/or the like. The specifications and makeup of the network switches in the topology affects the overall network performance (e.g., bandwidth capability) of the datacenter.

Datacenters are the storage and data processing hubs of the internet. The massive deployment of cloud applications is causing datacenters to expand exponentially in size, stimulating the development of faster switches than can cope with the increasing data traffic inside the datacenter. Current state-of-the-art switches are capable of handling 12.8 Tb/s of traffic by employing electrical switches in the form of application specific integrated circuits (ASICs) equipped with 256 data lanes, each operating at 50 Gb/s. Such switching ASICs typically consume as much as 400 W, and the power consumption of the optical transceiver interfaces attached to each ASIC is comparable. To keep pace with traffic demand, switch capacity doubles approximately every two years. To date, this rapid scaling has been made possible by exploiting advances in manufacturing (e.g., CMOS techniques), collectively described by Moore's law (i.e., the observation that the number of transistors in a dense integrated circuit doubles about every two years). However, in recent years there are strong indications of Moore's law slowing down, which raises concerns about the capability to sustain the target scaling rate of switch capacity. As a result, alternative technologies are being investigated.

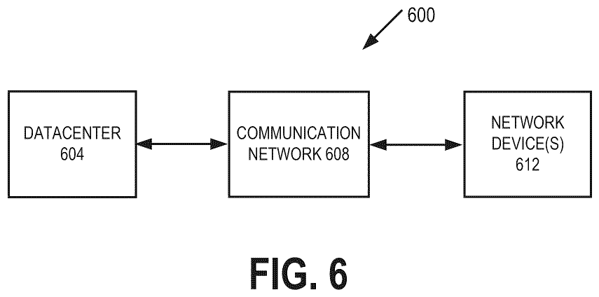

FIG. 6 illustrates a system 600 according to at least one example embodiment. The system 600 includes a datacenter 604, a communication network 608, and one or more network devices 612. In at least one example embodiment, the datacenter 604 corresponds to a collection of network devices, such as network switches (e.g., Ethernet switches) connected with a collection of servers or compute nodes. The datacenter 604 may adhere to a networking topology (e.g., a hierarchal networking topology), such as a fat tree topology, a Slim Fly topology, a Dragonfly topology, and/or the like. The datacenter 604 routes traffic amongst the network switches and servers therein, and at least one layer of the topology in the datacenter 604 is coupled to the communication network 608 to allow networking traffic to flow between the datacenter 604 and the network device(s) 612.

Examples of the communication network 608 that may be used to connect the datacenter 604 and the network device(s) 612 include an Internet Protocol (IP) network, an Ethernet network, an InfiniBand (TB) network, a Fibre Channel network, the Internet, a cellular communication network, a wireless communication network, combinations thereof (e.g., Fibre Channel over Ethernet), variants thereof, and/or the like.

The one or more network devices 612 may include switch, router or Network Interface Controller (NIC), interconnect using ports, one or more of Personal Computer (PC), a laptop, a tablet, a smartphone, a server, a collection of servers, and/or any suitable computing device for sending and receiving signals over the communication network 608. In at least one example embodiment, the one or more network devices 612 correspond to another datacenter, similar to or the same as datacenter 604.

As noted above, the datacenter 604 and/or the network device(s) 612 may include storage devices and/or processing circuitry for carrying out computing tasks, for example, tasks associated with controlling the flow of data internally and/or over the communication network 608. Such processing circuitry may comprise software, hardware, or a combination thereof. For example, the processing circuitry may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory).

Additionally or alternatively, the processing circuitry may comprise hardware, such as an application specific integrated circuit (ASIC). For example, the processor may be or include one or more of an Integrated Circuit (IC) chip, a microprocessor, a Central Processing Unit (CPU), a Graphics Processing Unit (GPU), a Data Processing Unit (DPU), a Field Programmable Gate Array (FPGA), a network interface card (NIC), an ASIC, combinations thereof, and the like. The processing circuitry may comprise an ASIC and/or may be capable of performing as a central processing unit (CPU), a graphics processing unit (GPU), a network interface card (NIC), a data processing unit (DPU), or any other computing device in which with data is received and/or transmitted.

Some or all of the processing circuitry may be provided on a Printed Circuit Board (PCB) or collection of PCBs. It should be appreciated that any appropriate type of electrical component or collection of electrical components may be suitable for inclusion in the processing circuitry.

In addition, although not explicitly shown, it should be appreciated that the datacenter 604 and network device(s) 612 may include one or more communication interfaces for facilitating wired and/or wireless communication between one another and other unillustrated elements of the system 600.

In related art systems, a fat tree topology may use the same electrical switching devices on all layers (edge, aggregation, core). For example, each switching device may be 1 U switch, where 1 U refers to the industry standard size for rack-mounted switch and/or server. The interconnection between switches of different layers may be accomplished with optical links using active optical cables and optical transceivers implemented in a pluggable form factor (also referred to as “pluggables”).

Optical Datacenter Networks rely on allocation and deallocation of light paths from the data sources to the destinations end-ports to guarantee no light collisions and data loss occur in the fabric. Traditionally the allocation algorithms are run from a central entity which considers the entire demand for source and destination flows and try to find the most dense mapping of these demands to network resources over a single or multiple time periods.

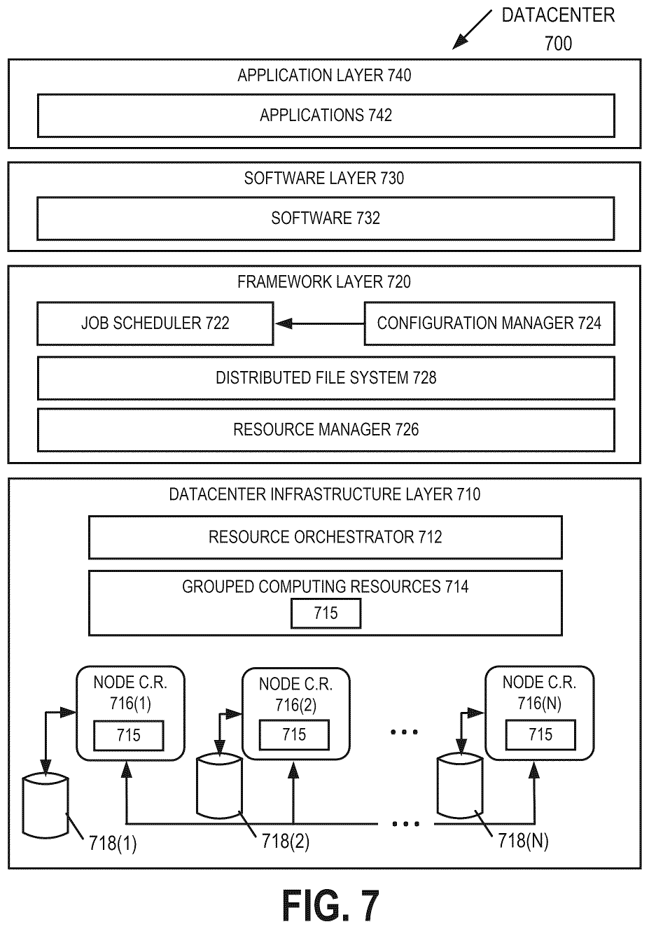

FIG. 7 illustrates an example datacenter 700, in which at least one embodiment may be used. In at least one embodiment, datacenter 700 includes a datacenter infrastructure layer 710, a framework layer 720, a software layer 730, and an application layer 740.

In at least one embodiment, as shown in FIG. 7, datacenter infrastructure layer 710 may include a resource orchestrator 712, grouped computing resources 714, and node computing resources (“node C.R.s”) 716(1)-716(N), where “N” represents a positive integer (which may be a different integer “N” than used in other figures). In at least one embodiment, node C.R.s 716(1)-716(N) may include, but are not limited to, any number of central processing units (“CPUs”) or other processors (including accelerators, field programmable gate arrays (FPGAs), graphics processors, etc.), memory storage devices 718(1)-718(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in datacenters at various geographical locations (also not shown). In at least one embodiment, separate groupings of node C.R.s within grouped computing resources 714 may include grouped compute, network, memory, or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for datacenter 700. In at least one embodiment, resource orchestrator 712 may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 728 for large-scale data processing (e.g., “big data”). In at least one embodiment, job scheduler 722 may include a Spark driver to facilitate scheduling of workloads supported by various layers of datacenter 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resources 714 at datacenter infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. In at least one embodiment, one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a datacenter operator of datacenter 700 from making possibly bad configuration decisions and possibly avoiding underutilized and/or poor performing portions of a datacenter.

In at least one embodiment, datacenter 700 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 700. In at least one embodiment, trained machine learning models corresponding to one or more neural networks may be used to infer or predict information using resources described above with respect to datacenter 700 by using weight parameters calculated through one or more training techniques described herein.

In at least one embodiment, datacenter may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 7 for inferencing or predicting operations based, at least in part, on weight parameters calculated using neural network training operations, neural network functions and/or architectures, or neural network use cases described herein.

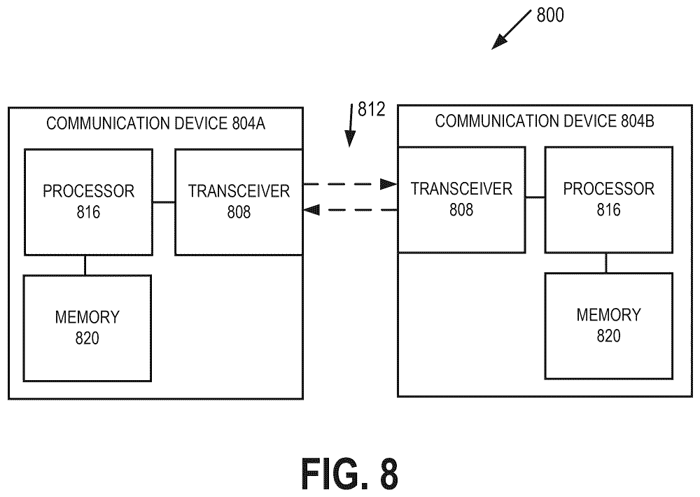

FIG. 8 illustrates a system 800 including a first communication device 804A and a second communication device 804B. Illustratively, but without limitation, the communication devices 804 (e.g., 804A, 804B) may correspond to network devices (e.g., network devices 612). As such, the communication devices 804 may correspond to any type of device that becomes part of or is connected with a communication network (e.g., communication network 608). Examples of suitable devices that may act or operate like a communication device 804 as described herein include, without limitation, one or more of a Personal Computer (PC), a laptop, a tablet, a smartphone, a server, a collection of servers, a networking card, an edge router, a switch, Network Interface Cards, a Top of Rack (ToR) switch, a server blade, or the like. The communication device 804 may include a transceiver 808, a processor 816, and memory 820. The transceiver 808 may include hardware that enables communications over the communication channel 812 whereas the processor 816 and memory 820 may include components that enable the communication device 804 to provide a desired functionality or perform certain functions.

The communication channel 812 may traverse a datacenter or any type of communication network (whether trusted or untrusted). Examples of a communication network that may be used to connect communication devices 804 and support the communication channel 812 include, without limitation, an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. In one specific, but non-limiting example, the communication network enables data transmission between the communication devices 804 using optical signals. In this case, the communication devices 804 and the communication network may include waveguides (e.g., optical fibers) that carry the optical signals. For example, the communication devices and/or the communication network may include one or more systems 400, according to various embodiments.

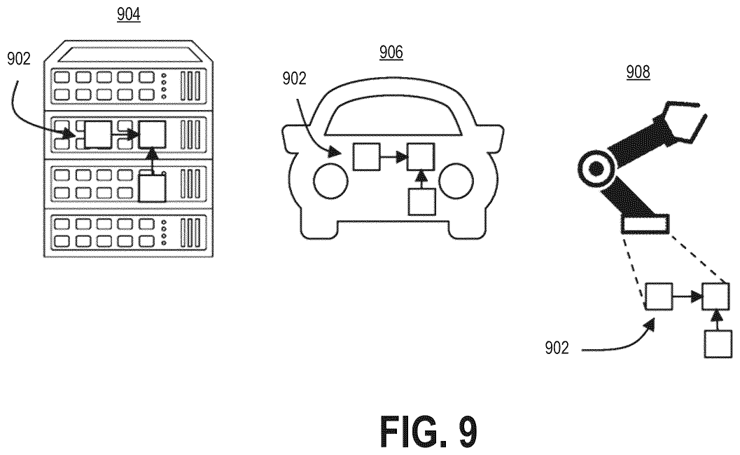

FIG. 9 depicts some exemplary scenarios for use of an optical transceiver 902 in accordance with some embodiments. An optical transceiver 902 may be utilized in a computing system 904 (e.g., in a server farm, or within a server computer system), a vehicle 906 (e.g., a car, truck, train, or airplane), and a robot 908 (or among robots in a factory), to name just a few examples. The optical transceiver 302 may be particularly useful for high-speed communication in environments subject to high levels of electromagnetic interference (EMI).

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A frequency comb generator comprising:
an optical cavity having gain material disposed therein; and
two or more waveguide gratings formed sequentially in the optical cavity, wherein the two or more waveguide gratings are configured to control an emission spectrum of the frequency comb generator.

2. The frequency comb generator of claim 1 further comprising:
a reflector; and
a saturable absorber,
wherein the reflector and the saturable absorber define the optical cavity.

3. The frequency comb generator of claim 2, wherein an anti-reflective coating is disposed on an outer surface of the saturable absorber.

4. The frequency comb generator of claim 1 further comprising:
at least one of a waveguide or cladding extending along an optical axis defined by the optical cavity and in optical communication with the gain material.

5. The frequency comb generator of claim 4, wherein the two or more waveguide gratings are formed in the at least one of the waveguide or the cladding.

6. The frequency comb generator of claim 5, wherein the two or more waveguide gratings are formed by patterning at least one of the waveguide or the cladding.

7. The frequency comb generator of claim 5, wherein the two or more waveguide gratings are formed by modulating a refractive index of the at least one of the waveguide or the cladding along at least a portion of the optical axis.

8. The frequency comb generator of claim 1, wherein the two or more waveguide gratings are configured to cause a reflected subset of spectral lines formed by the optical cavity to remain within the optical cavity and to allow an emission subset of spectral lines formed by the optical cavity to be emitted from the optical cavity.

9. The frequency comb generator of claim 8, wherein the optical cavity is configured to use spectral lines of the reflected subset of spectral lines to perform four wave mixing within the optical cavity.

10. The frequency comb generator of claim 1, wherein the two or more waveguide gratings define respective passbands, the optical cavity generates a plurality of spectral lines, and the frequency comb generator emits an emission subset of the plurality of spectral lines, where each emitted line in the emission subset is characterized by a respective wavelength that is within one of the respective passbands.

11. The frequency comb generator of claim 1, wherein a pitch of at least one of the two or more waveguide gratings is chirped.

12. The frequency comb generator of claim 1, wherein a pitch of at least one of the two or more waveguide gratings is constant across the at least one of the two or more waveguide gratings.

13. The frequency comb generator of claim 1, wherein the optical cavity is one of a closed loop cavity, a Fabry-Perot cavity, or a colliding pulse cavity.

14. The frequency comb generator of claim 1, wherein the optical cavity is optically coupled to an output waveguide and the frequency comb generator is configured to provide frequency comb pulses to the output waveguide comprising an emission subset of spectral lines that is defined at least in part by the two or more waveguide gratings.

15. A system comprising:
a frequency comb generator;
an output waveguide optically coupled to the frequency comb generator; and
one or more downstream elements,
wherein the frequency comb generator comprises:
an optical cavity having gain material disposed therein; and
two or more waveguide gratings formed sequentially in the optical cavity,
wherein the two or more waveguide gratings are configured to control an
emission spectrum of the frequency comb generator, and
wherein the output waveguide provides frequency comb pulses generated by the frequency comb generator to the one or more downstream elements.

16. The system of claim 15, wherein at least one of the one or more downstream elements is configured to perform dense wavelength division multiplexing using the frequency comb pulses.

17. The system of claim 15, wherein the two or more waveguide gratings define respective passbands, the optical cavity generates a plurality of spectral lines, and the frequency comb generator emits an emission subset of the plurality of spectral lines, where each emitted line in the emission subset is characterized by a respective wavelength that is within one of the respective passbands, and at least one of the one or more downstream elements is configured to perform dense wavelength division multiplexing using spectral lines of the emission subset.

18. The system of claim 15, wherein at least one of:
the system is a transceiver; or
at least one of the one or more downstream elements is a transceiver in optical communication with the output waveguide via an optical interconnect.

19. The system of claim 15, wherein the two or more waveguide gratings are configured to define a reflected subset of spectral lines formed by the optical cavity and an emission subset of spectral lines formed by the optical cavity, the reflected subset of spectral lines are caused to remain within the optical cavity and the emission subset of spectral lines are emitted from the optical cavity.

20. The system of claim 19, wherein the optical cavity is configured to use spectral lines of the reflected subset of spectral lines to perform four wave mixing within the optical cavity.

21. The system of claim 15, wherein the system is configured for performing at least one of artificial intelligence or machine learning functions.

22. A laser source for pluggable optical interconnects, the laser source comprising:
a frequency comb generator; and
an output waveguide optically coupled to the frequency comb generator,
wherein the frequency comb generator comprises:
an optical cavity having gain material disposed therein; and
two or more waveguide gratings formed sequentially in the optical cavity,
wherein the two or more waveguide gratings are configured to control an
emission spectrum of the frequency comb generator, and
wherein the output waveguide provides frequency comb pulses generated by the frequency comb generator to an optical interconnect.

23. A laser source for a chip-to-chip optical interconnect, the laser source comprising:
a frequency comb generator; and
an output waveguide optically coupled to the frequency comb generator,
wherein the frequency comb generator comprises:
an optical cavity having gain material disposed therein; and
two or more waveguide gratings formed sequentially in the optical cavity,
wherein the two or more waveguide gratings are configured to control an
emission spectrum of the frequency comb generator, and
wherein the output waveguide provides frequency comb pulses generated by the frequency comb generator to an optical interconnect.

24. A laser source for dense wavelength division multiplexing (DWDM), the laser source comprising:
a frequency comb generator; and
an output waveguide optically coupled to the frequency comb generator,
wherein the frequency comb generator comprises:
an optical cavity having gain material disposed therein; and
two or more waveguide gratings formed sequentially in the optical cavity,
wherein the two or more waveguide gratings are configured to control an
emission spectrum of the frequency comb generator, and
wherein the output waveguide provides frequency comb pulses generated by the frequency comb generator and spectral lines of the frequency comb pulses are configured for use as DWDM carrier signals.
